(19) United States
(12) Patent Application Publication
(10) Pub. No.: US 2006/0008058 A1
(43) Pub. Date: Jan. 12, 2006

(54) Remote wellness monitoring and communication

(76) Inventors: Jui-Lin Dai, Germantown, MD (US); Olena Mamykina, New York, NY (US); Stephen P. Masticola, Kingston, NJ (US); April McGee, Monmouth Junction, NJ (US); Rainer Michelis, Cranbury, NJ (US); David Rapaport, Marlboro, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/118,746

(22) Filed: Apr. 29, 2005

Related U.S. Application Data
(60) Provisional application No. 60/566,561, filed on Apr. 29, 2004.

(51) Int. Cl. H04M 11/04

(52) U.S. Cl. 379/37; 379/38

(57) ABSTRACT

System and method are provided for remotely monitoring an individual's health and safety and communicating information to appropriate personnel and services, wherein the individual wears a remote monitoring device or the individual is monitored by cameras. The remote monitoring device can be capable of being activated by the individual or can be capable of measuring vital sign functions of the individual. The occurrence of an indication requiring an emergency response is verified and the appropriate response is initiated. The travel of emergency response vehicles can be expedited by controlling traffic signals to favor the route of the emergency response vehicle. Communication between monitored individuals, monitoring agencies, databases, responding services, healthcare facilities and traffic controllers is integrated through the use of modern data and communication systems such as telephone, cable, wireless or the Internet.

### CROSS-REFERENCE TO RELATED APPLICATION

This application claims priority to U.S. Provisional Application Ser. No. 60/566,561 filed on Apr. 29, 2004, which is fully incorporated by reference.

### BACKGROUND

1. Technical Field

The present invention relates generally to health and safety monitoring and communication, and more particularly to an automated system and method for detecting a health or safety emergency and providing assistance for an incapacitated individual.

2. Discussion of Related Art

An elderly, ill or disabled individual living alone is at a disadvantage during the emergence of events such as an injuring fall, unconsciousness or some other disabling occurrence. The individual may be unable to summon assistance in a conventional manner such as placing a telephone call to a friend, neighbor, relative, physician or emergency service. In the event the individual is unable to reach a telephone or is otherwise incapacitated, the individual may not be able to receive timely medical attention or other required assistance. Additionally, the inability to continuously monitor an elderly, ill or disabled individual living alone can place stresses upon concerned relatives and friends.

### SUMMARY OF THE INVENTION

An exemplary embodiment of the present invention provides a remote wellness monitoring and communication system, comprising a monitoring system for capturing subscriber data, wherein the subscriber data comprises subscriber living space images and subscriber vital sign data, wherein the subscriber vital sign data comprises at least one of heart rate, blood pressure, blood sugar, blood-oxygen percentage, respiration rate, electrocardiographic data and electroencephalographic data, a monitoring agency server communicatively connected with the monitoring system for receiving the subscriber data an automated vital sign analysis system communicatively connected with the monitoring agency server for analyzing the subscriber vital sign data, wherein the automated vital sign analysis system detects deviations existing in the subscriber vital sign data and an automated imaging system communicatively connected with the monitoring agency server for analyzing the subscriber living space images, wherein the automated imaging system detects deviations existing in the subscriber living space images.

Another exemplary embodiment of the present invention provides a remote wellness monitoring and communication method, comprising the steps of monitoring subscriber data, wherein the subscriber data comprises subscriber living space images and subscriber vital sign data, wherein the subscriber vital sign data comprises at least one of heart rate, blood pressure, blood sugar, blood-oxygen percentage, respiration rate, electrocardiographic data and electroencephalographic data, automatically detecting subscriber data indicating a deviation, verifying subscriber data indicating a deviation and alerting at least one of subscriber designated contacts, emergency response facilities and healthcare facilities.

Still another exemplary embodiment of the present invention provides a remote wellness monitoring agency system for receiving and processing subscriber data to automatically detect subscriber data indicating a deviation, wherein the subscriber data comprises subscriber living space images.

Yet another exemplary embodiment of the present invention provides a remote wellness monitoring and communication method, comprising the steps of automatically detecting subscriber data indicating a deviation, wherein the subscriber data comprises subscriber living space images, verifying subscriber data indicating a deviation and alerting at least one of subscriber designated contacts, emergency response facilities and healthcare facilities.

### BRIEF DESCRIPTION OF THE DRAWINGS

FIG. 1 is a block diagram illustrating a remote wellness monitoring and communication system, according to an exemplary embodiment of the present invention.

FIG. 2 is a flow diagram illustrating a method for providing remote wellness monitoring and communication, according to an exemplary embodiment of the present invention.

### DETAILED DESCRIPTION OF EXEMPLARY EMBODIMENTS

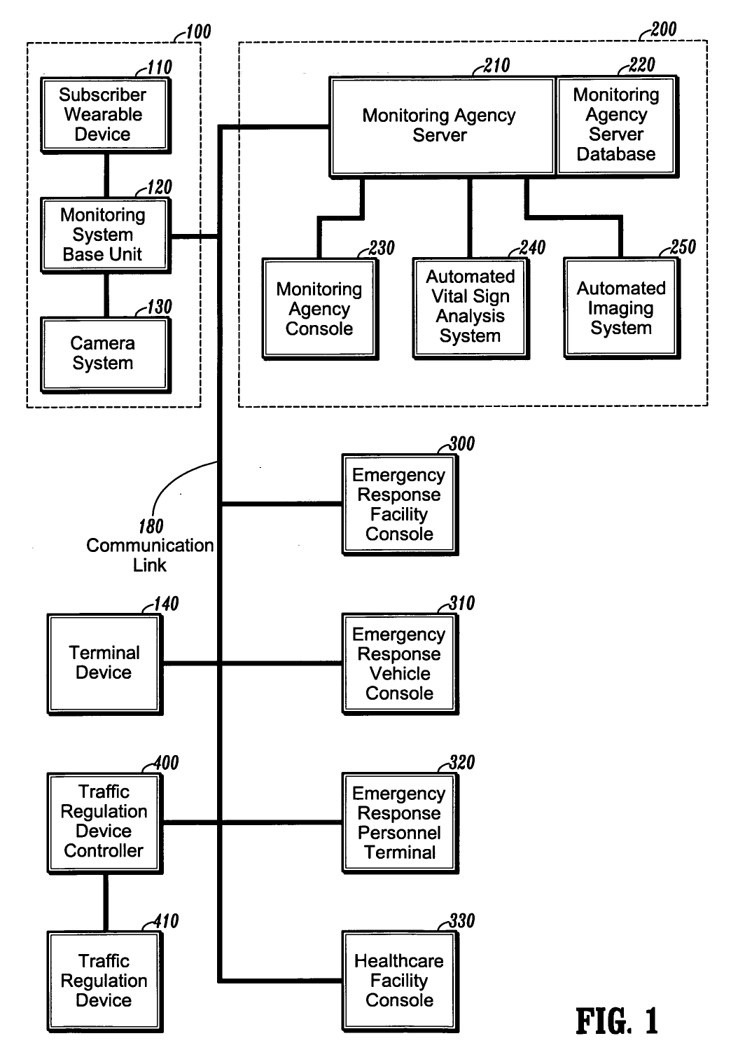

FIG. 1 is a block diagram illustrating a remote wellness monitoring and communication system, according to an exemplary embodiment of the present invention. A remote wellness monitoring and communication system utilizes a monitoring system 100 for capturing subscriber data relating to the subscriber's health and safety such as a subscriber initiated request for assistance, the subscriber's vital sign data or the subscriber's living space images. A monitoring system 100 can comprise a subscriber wearable device 110, such as but not limited to a pendant or a wrist-worn unit. However, several other types of subscriber wearable devices 110 are contemplated depending on the nature of the monitoring to be accomplished. The subscriber wearable device 110 can receive the subscriber's request for assistance or can directly monitoring a vital sign parameter of the subscriber such as heart rate, blood pressure, blood sugar, blood-oxygen percentage, respiration rate, electrocardiographic data and electroencephalographic data.

A request for assistance or a vital sign parameter can be transmitted to a monitoring system base unit 120 that can be located within the subscriber's living space. The remote monitoring base unit 120 transmits the request for assistance or the vital sign parameters to a monitoring agency system 200 over a communication link 180. The communication link 180 can be the Internet or could be a standard or dedicated telephone connection, a cable connection, a wireless communication channel, or any of several alternate communication links.

Alternatively or additionally, the monitoring system 100 can comprise a camera system 130 located within the subscriber's living space along with any necessary supporting camera system equipment. The subscriber's living space can be any area temporarily or permanently occupied by an individual to be monitored including but not limited to a residence room, apartment, house, hotel room, hospital room, office, or any area where the individual will spend time for work, recreation, food preparation or any normal activity. The camera system 130 can transmit images of the subscriber's living space to the monitoring system base unit 120 for transmission to the monitoring agency system 200 over the communication link 180.

The monitoring agency system 200 receives data from the monitoring system 100 such as receiving requests for assistance, or periodically monitoring subscriber vital sign parameters or subscriber living space images.

A monitoring agency system 200 can comprise a monitoring agency server 210 that includes a monitoring agency server database 220 for Storing subscriber information such as name, address, telephone number, other personal information, contact information, medical information, medical history, type of monitoring service, stored subscriber living space images and any other relevant information.

The monitoring agency server 210 can be connected to a monitoring agency console 230 so that monitoring agency attendants can receive alerts from the monitoring agency server 210. Alerts can be generated by a subscriber's request for assistance, a deviation in the subscriber's monitored vital sign parameters or a deviation in the received subscriber living space images.

The monitoring agency server 210 can include or have connected with it an automated vital sign analysis system 240 having access to the monitoring agency server database 220. The automated vital sign analysis system 240 can recognize the normal stored subscriber's vital sign parameters present in the monitoring agency server database 220. The subscriber's monitored vital sign parameters can be compared to preset vital sign parameters stored in the monitoring agency server database 220. As an example, where a physician has determined that an alert should be generated anytime a particular subscriber's heart rate falls outside the range of 52 and 92 beats per minute for more than 2 minutes and a subscriber's heart rate is over 94 beats per minute for three minutes, an alert could be generated. Deviations from the preset allowable range of vital sign parameters can generate an alert that is posted to the monitoring agency console 230.

The monitoring agency server 210 can include or have connected with it an automated imaging system 250 having access to the monitoring agency server database 220. The automated imaging system 250 can recognize the normal stored subscriber's living space images present in the monitoring agency server database 220. By employing pattern recognition techniques, which are well known in the art, it can detect differences in the received subscriber living space images from the stored subscriber living space images. The received subscriber living space images can change due to normal movement throughout the living space, and the automated imaging system 250 can discern these types of differences. A deviation in the received subscriber living space image results, for example, if the subscriber were to lay relatively motionless for an extended time in an unusual location such as on the kitchen or bathroom floor. When the automated imaging system 250 detects a deviation in the received living space images, an alert is posted to the monitoring agency console 230 even though the subscriber was otherwise unable to summon assistance. The automated imaging system 250 can protect the subscriber's privacy since monitoring agency personnel do not view the subscriber living space images unless the automated imaging system 250 detects a deviation in the received subscriber living space images. Also, the use of the automated imaging system 250 allows for the continuous monitoring of a subscriber without incurring the costs of employing supervisory personnel for the task.

Upon receipt of an alert, a monitoring agency attendant can verify the nature of the alert. In the case of an alert due to a deviation in the received subscriber living space images, the attendant can view the received subscriber living space images on the monitoring agency console 230. In each of the alert cases, the monitoring agency attendant can attempt to contact the subscriber or a designated contact or summon an emergency response facility. The monitoring agency attendant can utilize any number of types of communication systems in order to make the required contact such as telephone, Internet or wireless communications. An emergency response facility can be in communication with the monitoring agency attendant via normal communication systems such as telephone, Internet or wireless communications or via a console device connected over the communication link 180. For a minor alerting event it may be sufficient to inform one of the designated contacts such as a concerned relative, neighbor or friend. For more serious alerting events, a healthcare professional such as a family physician or an emergency response facility can be summoned so they can dispatch emergency response personnel and vehicles such as paramedics, emergency medical technicians, an ambulance or a med-evac helicopter.

The subscriber or a subscriber's designated contact person such as a concerned relative, a friend, or a healthcare professional can update selected information contained in the monitoring agency server database 220 by communicating with the monitoring agency server 210 via the communication link 180 by using a terminal device 140 such as a home or office computer, Web TV, a dedicated console device, a telephone device, a wireless communication device or any number of alternate communication devices.

Emergency response facilities can be equipped with emergency response facility consoles 300 connected via the communication link 180. Selected information can be sent to the emergency response facility consoles 300 by the monitoring agency attendants including monitoring agency attendant initiated messages or information from the monitoring agency server database 220 such as the subscriber's personal information, medical history or current vital sign information. Emergency response attendants can dispatch emergency response personnel such as paramedics or emergency medical technicians, and emergency response vehicles such as ambulances or helicopters. The emergency response vehicles can be equipped with emergency response vehicle consoles 310 in communication with the emergency response facility consoles 300, the monitoring agency consoles 230, the monitoring agency server 210 or healthcare facility consoles 330, by utilizing direct wireless communication channels or the communication link 180. The emergency response personnel can communicate via voice or transmitted text with the emergency response facility personnel, the monitoring agency attendants, the healthcare facility personnel, and receive and transmit information such as selected subscriber information, medical history and treatment advice. The emergency response personnel can be equipped with emergency response personnel terminals 320 that are also in communication via voice or transmitted text with the emergency response vehicle console 310, the emergency response facility console 300, the monitoring agency consoles 220, the monitoring agency server 200 and the healthcare facility consoles 330, by using direct wireless communication or the communication link 180.

Healthcare facilities can be hospitals, emergency rooms, trauma centers, first-aid facilities or other facilities for patient treatment. Medical personnel located at healthcare facilities and using healthcare facility consoles 330 or other communication devices can receive selected subscriber information to assist in the admission process-such as insurance information and can interact with the emergency response personnel regarding treatment related information such as treatment instructions, drug interactions or allergies. The healthcare facility personnel can also receive the subscriber's medical history and current vital sign information.

To expedite emergency response vehicle travel time, an embodiment of the present invention includes the transmission of emergency response vehicle route information and emergency response vehicle location, determined by a global positioning system or other similar device, via the communication link 180 to traffic regulation device controllers 400 so that traffic flow can be managed with respect to the status of traffic regulation devices 410 such as traffic signals directing the flow of traffic.

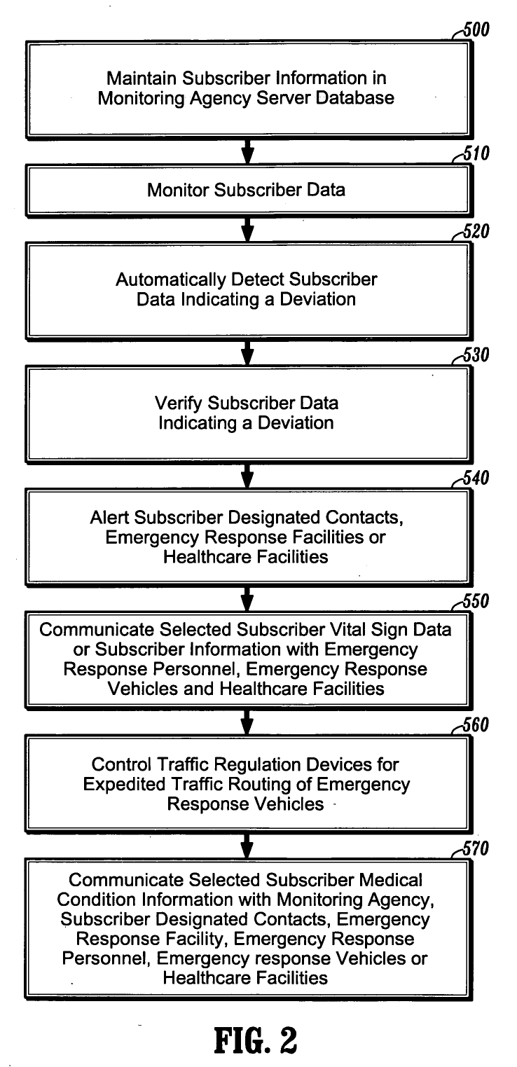

FIG. 2 is a flow diagram illustrating a method for providing remote wellness monitoring and communication, according to an exemplary embodiment of the present invention. An individual requiring supervision for health or safety reasons can subscribe to a monitoring agency that provides a service that receives health and safety information from the subscriber. The monitoring agency determines if a deviation in the received subscriber data signifies that an emergency situation exists that requires assistance for the subscriber and makes assistance available to the subscriber. The method steps in one embodiment comprise monitoring 510 subscriber data, automatically detecting 520 subscriber data indicating a deviation, verifying 530 subscriber data indicating a deviation, and alerting 540 at least one of subscriber designated contacts, emergency response facilities and healthcare facilities.

Monitoring 510 subscriber data includes having a subscriber utilize a monitoring system that detects a subscriber initiated request for assistance or that detects subscriber vital sign data. Monitoring 510 subscriber data also includes having a subscriber's living space observed by a camera that detects an event requiring assistance, such as a subscriber's fall or unconsciousness. Vital sign data can be a subscriber vital sign parameter such as heart rate, blood pressure, blood sugar, blood-oxygen percentage, respiration rate, electrocardiographic data and electroencephalographic data.

Automatically detecting 520 subscriber data indicating a deviation is where a monitoring agency, for instance, has appropriate equipment for receiving and analyzing subscriber data to detect deviations from preset norms. In an exemplary embodiment, the appropriate equipment is a monitoring agency server including a monitoring agency server database and optionally connected with an automated vital sign analysis system or an automated imaging system. The monitoring agency server is provided with software to alert a monitoring agency attendant via a monitoring agency console where a subscriber requests assistance, a subscriber vital sign parameter, such as heart rate, blood pressure, blood sugar, blood-oxygen percentage, respiration rate, electrocardiographic data and electroencephalographic data, is out of a predetermined range, or an image from a subscriber's living space shows a significant change in the image received indicating a deviation. In the case of a deviation, the subscriber's living space image can be displayed on the monitoring agency console.

Verifying 530 subscriber data indicating a deviation is where a monitoring agency attendant, for example, attempts to determine if a deviation in the received subscriber data signifies that an emergency situation exists that requires assistance for the subscriber. The monitoring agency attendant can review the subscriber's vital sign parameters or living space image, or attempt to contact the subscriber or a designated contact.

Alerting 540 at least one of subscriber designated contacts, emergency response facilities and healthcare facilities results when the monitoring agency attendant is unable to contact the subscriber or otherwise determines that assistance is required. If the subscriber cannot be contacted, the monitoring agency server can display a predetermined procedure on the monitoring agency console for the monitoring agency attendant to follow in communicating with designated contacts or summoning emergency response facilities such as an ambulance corps or a healthcare facility such as a trauma center, depending on the severity of the emergent indications.

Another embodiment further comprises maintaining 500 subscriber information in monitoring agency server database, communicating 550 selected vital sign data and subscriber information with emergency response personnel, emergency response vehicles and healthcare facilities, controlling 560 traffic regulation devices for expedited traffic routing of emergency response vehicles, and communicating 570 subscriber medical condition information with healthcare facilities.

Maintaining 500 subscriber information in monitoring agency server database includes entering, displaying or amending the subscriber's personal information such as address information, designated contacts, prescriptions, medical history, treating physicians and treatment which can be performed via terminals such as home or office computers, telephones or wireless devices. The Internet, Web TV, telephone system, etc. can be used in communicating this information. The editing can be performed by the subscriber or a designated contact.

Communicating 550 selected vital sign data and subscriber information with emergency response personnel, emergency response vehicles and healthcare facilities allows a monitoring agency attendant or emergency response facility personnel to alert a healthcare facility of the subscriber's arrival by communicating selected subscriber information with the healthcare facility which can expedite the subscriber's admission to the healthcare facility by supplying the healthcare facility with the subscriber's insurance information. Also, while a subscriber is being attended to, emergency response personnel can communicate the subscriber's current medical condition with the monitoring agency attendant, the emergency response facility, or healthcare facility personnel such as treating physicians. The healthcare facility treating physicians can advise the emergency response personnel of possible drug interactions, allergic interactions, and treatment options. The emergency response personnel can also advise the healthcare facility of the subscriber's expected time of arrival and pertinent treatment that has been performed as well as requirements.

While enroute to the subscriber's location or to a healthcare facility, the emergency response vehicle's time enroute can be improved by controlling 560 traffic regulation devices by communicating the emergency response vehicle's location and route information with traffic regulation device controllers so that the traffic regulation devices can assist the emergency response vehicle's travel by, for example, changing traffic light signals to favor the emergency response vehicle's passage through intersections.

Emergency response personnel can communicate 570 the subscriber's medical condition with healthcare facilities for several purposes, including preparing the healthcare facility personnel for the subscriber's arrival and treatment requirements, and for the healthcare facility personnel to advise the emergency response personnel with treatment options, drug interactions and allergies.

In another exemplary embodiment, communicating subscriber data to a monitoring agency server is a continuous process where the monitoring system through various equipment and channels relays the subscriber data to a facility wherein the subscriber's vital sign data is analyzed. An appropriate facility can be a monitoring agency that provides a service of continuously observing a subscriber's data.

Although exemplary embodiments have been described herein with reference to the accompanying drawings, it is to be understood that the present disclosure is not limited to those exemplary embodiments, and that various changes and modifications can be effected therein by one of ordinary skill in the pertinent art without departing from the scope or spirit of the present disclosure. All such changes and modifications are intended to be included within the scope of the present disclosure as set forth in the appended claims.

What is claimed is:

1. A remote wellness monitoring and communication system, comprising:
a monitoring system for capturing subscriber data, wherein the subscriber data comprises subscriber living space images and subscriber vital sign data, wherein the subscriber vital sign data comprises at least one of heart rate, blood pressure, blood sugar, blood-oxygen percentage, respiration rate, electrocardiographic data and electroencephalographic data;
a monitoring agency server communicatively connected with the monitoring system for receiving the subscriber data;
an automated vital sign analysis system communicatively connected with the monitoring agency server for analyzing the subscriber vital sign data, wherein the automated vital sign analysis system detects deviations existing in the subscriber vital sign data; and,
an automated imaging system communicatively connected with the monitoring agency server for analyzing the subscriber living space images, wherein the automated imaging system detects deviations existing in the subscriber living space images.

2. The remote wellness monitoring and communication system of claim 1, wherein the monitoring agency server comprises a monitoring agency server database for storing subscriber information.

3. The remote wellness monitoring and communication system of claim 1, comprising a monitoring agency console communicatively connected with the monitoring agency server for displaying at least one of subscriber information, subscriber vital sign data, alerts generated by the automated vital sign analysis system, subscriber living space images and alerts generated by the automated imaging system.

4. The remote wellness monitoring and communication system of claim 1, wherein the monitoring system comprises a camera system for capturing said subscriber living space images.

5. The remote wellness monitoring and communication system of claim 1, wherein the monitoring system comprises a subscriber wearable device for capturing subscriber vital sign data or a subscriber initiated request for assistance.

6. The remote wellness monitoring and communication system of claim 1, wherein the subscriber data further comprises a subscriber initiated request for assistance.

7. The remote wellness monitoring and communication system of claim 1, wherein the monitoring system comprises a monitoring system base unit for transmitting the subscriber data to the monitoring agency server.

8. The remote wellness monitoring and communication system of claim 1, further comprising a terminal device communicatively connected with the monitoring agency server to enter, update or display subscriber information.

9. The remote wellness monitoring and communication system of claim 1, further comprising an emergency response facility console communicatively connected with at least one of the monitoring agency server, a monitoring agency console, an emergency response vehicle console, an emergency response personnel terminal and a healthcare facility console.

10. The remote wellness monitoring and communication system of claim 1, further comprising an emergency response vehicle console communicatively connected with at least one of the monitoring agency server, a monitoring agency console, an emergency response facility console, an emergency response personnel terminal and a healthcare facility console.

11. The remote wellness monitoring and communication system of claim 1, further comprising an emergency response personnel terminal communicatively connected with at least one of the monitoring agency server, a monitoring agency console, an emergency response facility console, an emergency response vehicle console and a healthcare facility console.

12. The remote wellness monitoring and communication system of claim 1, further comprising a healthcare facility console communicatively connected with at least one of the monitoring agency server, a monitoring agency console, an emergency response facility console, an emergency response vehicle console and an emergency response personnel terminal.

13. The remote wellness monitoring and communication system of claim 1, further comprising a traffic regulation device controller communicatively connected with at least one of the monitoring agency server, an emergency response facility console, and an emergency response vehicle console for receiving commands to operate traffic regulation devices to provide expedited traffic flow for emergency response vehicles.

14. A remote wellness monitoring and communication method, comprising the steps of:
monitoring subscriber data, wherein the subscriber data comprises subscriber living space images and subscriber vital sign data, wherein the subscriber vital sign data comprises at least one of heart rate, blood pressure, blood sugar, blood-oxygen percentage, respiration rate, electrocardiographic data and electroencephalographic data;
automatically detecting subscriber data indicating a deviation;
verifying subscriber data indicating a deviation; and,
alerting at least one of subscriber designated contacts, emergency response facilities and healthcare facilities.

15. The remote wellness monitoring and communication method of claim 14, wherein the subscriber data further comprises subscriber initiated requests for assistance.

16. The remote wellness monitoring and communication method of claim 14, further comprising the step of maintaining subscriber information in a monitoring agency server database.

17. The remote wellness monitoring and communication method of claim 14, further comprising the step of communicating selected subscriber vital sign data or subscriber information with at least one of emergency response personnel, emergency response vehicles and healthcare facilities.

18. The remote wellness monitoring and communication method of claim 14, further comprising the step of controlling traffic regulation devices for expedited traffic routing of the emergency response vehicles.

19. The remote wellness monitoring and communication method of claim 14, further comprising the step of communicating selected subscriber medical condition information with at least one of monitoring agency, subscriber designated contacts, emergency response facilities, emergency response personnel, emergency response vehicles and healthcare facilities.

20. A remote wellness monitoring agency system for receiving and processing subscriber data to automatically detect subscriber data indicating a deviation, wherein the subscriber data comprises subscriber living space images.

21. The remote wellness monitoring agency system of claim 20, wherein the subscriber data further comprises subscriber initiated requests for assistance or subscriber vital sign data, wherein the subscriber vital sign data comprises at least one of heart rate, blood pressure, blood sugar, blood-oxygen percentage, respiration rate, electrocardiographic data and electroencephalographic data.

22. A remote wellness monitoring and communication method, comprising the steps of:
automatically detecting subscriber data indicating a deviation, wherein the subscriber data comprises subscriber living space images;
verifying subscriber data indicating a deviation; and,
alerting at least one of subscriber designated contacts, emergency response facilities and healthcare facilities.

23. The remote wellness monitoring and communication method of claim 22, wherein the subscriber data further comprises subscriber initiated requests for assistance or subscriber vital sign data, wherein the subscriber vital sign data comprises at least one of heart rate, blood pressure, blood sugar, blood-oxygen percentage, respiration rate, electrocardiographic data and electroencephalographic data.
